(19) United States
(12) Patent Application Publication
(10) Pub. No.: US 2026/0269094 A1
(43) Pub. Date: Sep. 10, 2026

(54) FLOW CALMING ASSEMBLY FOR NUCLEAR REACTOR, AND ASSOCIATED REACTOR AND METHOD

(71) Applicant: FRAMATOME, COURBEVOIE (FR)

(72) Inventors: Laurent CAHOUET, CHAUDENAY (FR); Aurélien GAILLARD, PARIS (FR); Philippe MARTINEZ, HERBLAY (FR); Denis POLLIER, GIVRY (FR); Bastien VAYSSETTE, ASNIERES SUR SEINE (FR)

(21) Appl. No.: 18/723,256

(22) PCT Filed: Dec. 22, 2021
(86) PCT No.: PCT/IB2021/000948

§ 371 Date: Jun. 21, 2024

(51) Int. Cl. G21C 15/243

(52) U.S. Cl. CPC G21C 15/243

(57) ABSTRACT

A flow calming assembly for a nuclear reactor includes a vessel and an enclosure situated in the vessel. A fluid circulates from the vessel to the enclosure at a bottom part of the vessel. The flow calming assembly includes an outer calming device with openings for fluid passage, the outer calming device includes an upper part and a lower part. The upper part includes a flared or conical collar extending between an upper end and a lower end, the lower part having a shape presenting a symmetry along a main axis, the lower part extending from the lower end of the upper part. The present disclosure also includes an associated reactor and an installing method.

### CROSS-REFERENCE TO RELATED APPLICATIONS

This application is the U.S. National Phase of PCT Appl. No. PCT/IB2021/00948 filed Dec. 22, 2021, the entire disclosures of which are incorporated by reference herein.

### TECHNICAL FIELD

The present disclosure relates to a flow calming assembly for a nuclear reactor comprising a vessel and an enclosure situated in the vessel wherein a fluid circulates from the vessel to the enclosure at a bottom part of the vessel.

### BACKGROUND

The present disclosure further relates to an associated nuclear reactor and an associated method for installing an outer calming device in a nuclear reactor.

When the fluid reaches the bottom of the vessel and turns to enter the enclosure comprising the nuclear core, the fluid flow rate can fluctuate. This may lead to fluctuations in the observed nuclear power, that may result in further limiting the reactor power.

EP 3 729 464 B1 describes a nuclear reactor comprising a vessel, an enclosure located inside the vessel, the low end of the enclosure being open in such a way as to allow a fluid to circulate from the injection circuits, to the vessel bottom then to penetrate and to circulate through the enclosure, and a diffusion element of flows configured for making the flow entering into the enclosure uniform. The diffusion element defines a mixing zone free of any obstacle between said diffusion element and the vessel bottom.

The diffusion element comprises a substantially circular or polygonal flat surface portion with a plurality of orifices, the flat portion being located at a first distance from a support and at a second distance from the lower limit of the vessel bottom, the second distance being greater than the first distance.

However, this leads to a region of conjunction of the flows coming from the different injection circuits at the bottom of the vessel which can be the source of strong unsteady swirls.

### SUMMARY

One aim of the present disclosure is therefore to provide a flow calming assembly for effectively calming the flow between the vessel and the enclosure.

To that end, the present disclosure relates to a flow calming assembly of the aforementioned type, wherein the flow calming assembly comprises an outer calming device, the outer calming device having openings for fluid passage, the outer calming device comprising an upper part and a lower part, the upper part comprising a flared or conical collar extending between an upper end and a lower end, the lower part having a shape presenting a symmetry along a main axis, the lower part extending from the lower end of the upper part.

The presence and shape of the outer calming device effectively calms the flow and favors a proper turn of the flow within the lower plenum. A proper turn results in a stable and controlled swirl at the region of conjunctions that improves the mixing and limits spatial and temporal heterogeneity of mass flow rate at enclosure inlet. Indeed, the better the mixing, the better the operating of the core within the enclosure.

According to specific embodiments of the present disclosure, the flow calming assembly has one or more of the following features, considered alone or according to any technically possible combination(s):
the flow calming assembly comprises a flow distribution device for distributing a flow of the fluid from the vessel to the enclosure, the outer calming device radially surrounding the flow distribution device;
the outer calming device is configured to have no contact with any pressurized element of the vessel;
the upper end of the upper part has greater dimensions than the lower end;
the upper part comprises a flared or conical collar with a circular base, the lower part being cylindrical;
the lower part is provided with a plurality of rows of through-holes, the rows being staggered relative to the adjacent rows;
the upper part is provided with a plurality of apertures;
the lower part radially surrounds the flow distribution device;
the outer calming device is adapted to extend from a bottom portion of the enclosure to a distance between 0.5 centimeters and 10 centimeters to the bottom surface of the vessel;
the outer calming device is provided with a plurality of fasteners attached to an upper end of said outer calming device for fastening the outer calming device inside the vessel; and/or
the outer calming device is provided with a plurality of indexing elements, the indexing elements being adapted to cooperate with an insertion and/or extraction tool such as to insert or extract said outer calming device in or from the vessel.

The present disclosure further relates to a nuclear reactor comprising a vessel and an enclosure situated in the vessel wherein a fluid circulates from the vessel to the enclosure at a bottom part of the vessel, the nuclear reactor being provided with a flow calming assembly, wherein the flow calming assembly comprises an outer calming device, the outer calming device having openings for fluid passage, the outer calming device comprising an upper part and a lower part, the upper part comprising a flared or conical collar extending between an upper end and a lower end, the lower part having a shape presenting a symmetry along a main axis, the lower part extending from the lower end of the upper part.

The present disclosure further relates to a method for installing an outer calming device in a nuclear reactor comprising a vessel and an enclosure situated in the vessel, the nuclear reactor comprising a nuclear core located in the enclosure, a fluid circulating from the vessel to the enclosure at a bottom part of the vessel, the method comprising the following steps:
emptying the vessel of internal structures and the nuclear fuel assemblies,
providing an outer calming device, the outer calming device having openings for fluid passage, the outer calming device comprising an upper part and a lower part, the upper part comprising a flared or conical collar extending between an upper end and a lower end, the lower part having a shape presenting a symmetry along a main axis, the lower part extending from the lower end of the upper part,
lowering the outer calming device in the vessel,
fastening the outer calming device inside the vessel, and
reinstalling the internal structures and the nuclear fuel assemblies in the vessel.

According to specific embodiments of the present disclosure, the method has one or more of the following features, considered alone or according to any technically possible combination(s):
the outer calming device is fastened to protrusions radially protruding from an inner surface of the vessel and/or to a lower plate of the nuclear core; and/or
the outer calming device is fastened such that the outer calming device extends from a bottom portion of the enclosure to a distance between 0.5 centimeters and 10 centimeters to the bottom surface of the vessel.

### BRIEF DESCRIPTION OF THE DRAWINGS

Other features and advantages of the present disclosure will appear upon reading the following description, provided solely as an example and done in reference to the appended drawings in which:

FIG. 1 is a schematic representation of a bottom part of a vessel of a nuclear reactor with an example of a flow calming assembly of the present disclosure,

FIG. 2 is a representation in three dimensions of an outer calming device of the flow calming assembly of FIG. 1, and

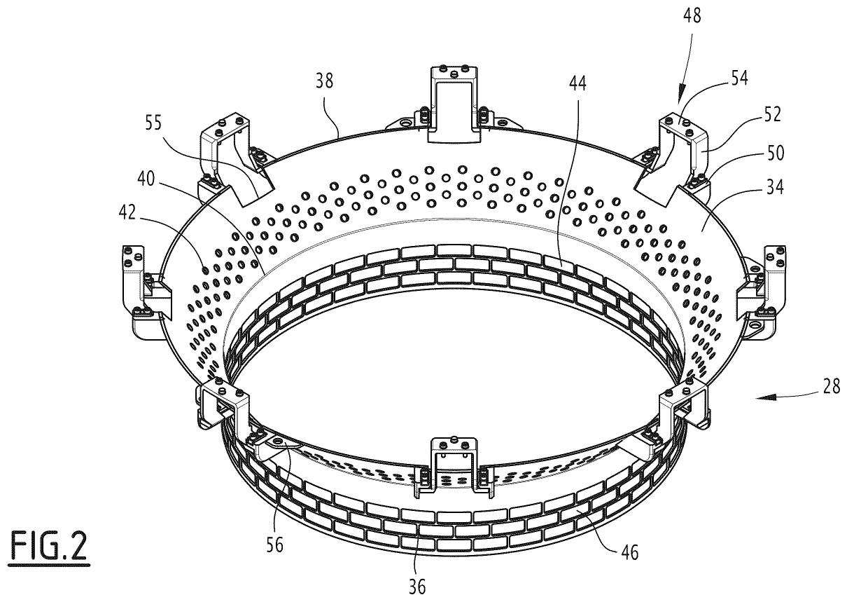

FIG. 3 is a representation in three dimensions of the outer calming device of FIG. 2, with an insertion and/or extraction tool.

### DETAILED DESCRIPTION

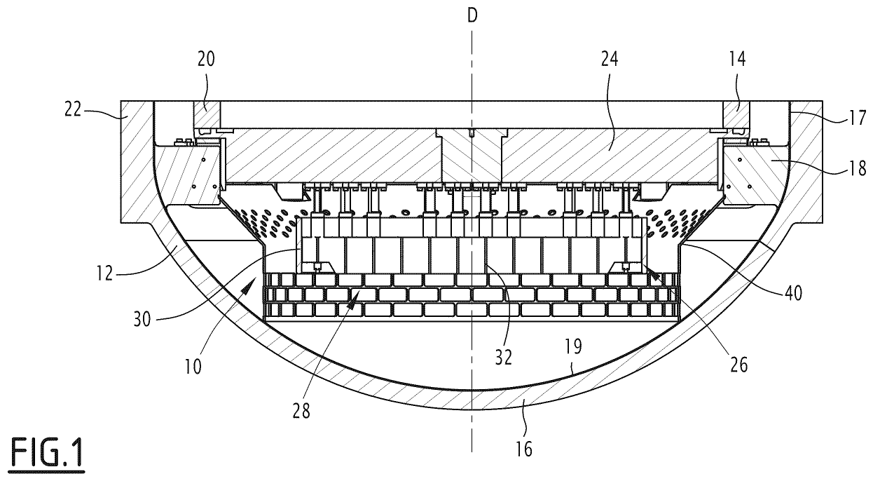

An example of a flow calming assembly is represented in FIG. 1.

The flow calming assembly 10 is adapted for a nuclear reactor comprising a vessel 12 and an enclosure 14 situated in the vessel 12.

the vessel 12 is delimited by an outer wall 16.

Said outer wall 16 defines an inner surface 17 of the vessel 12. Said inner surface 17 here comprises protrusions 18, protruding radially from said inner surface 17 towards the inside of the vessel, in particular towards the enclosure 14.

Said outer wall 16 defines a bottom surface 19 of the vessel 12.

The bottom surface 19 is part of the inner surface 17.

The enclosure 14 is delimited by an inner wall 20.

The inner wall 20 presents a symmetry along a main axis D.

The inner wall 20 corresponds to a given contour translated along an axis.

In the represented embodiment, said inner wall 20 is here cylindrical.

The enclosure 14 is open at the lower end of the enclosure 14.

The outer wall 16 comprises a side portion 22 radially surrounding the inner wall 20 of the enclosure 14.

The side portion 22 is substantially cylindrical.

A core is located inside the enclosure 14.

The core, for example, comprises nuclear fuel assemblies comprising nuclear rods.

The core is located above an inferior plate 24 provided with holes.

A fluid circulates from the vessel 12 to the enclosure 14 at a bottom part of the vessel 12.

More particularly, the fluid circulates in the space between the vessel 12 and the enclosure 14, more precisely between the outer wall 16 and the inner wall 20, downwards, and then from the vessel 12 to the enclosure 14 at the lower end of the enclosure 14.

The fluid thus penetrates the enclosure 14 and circulates within the enclosure 14.

The space between the vessel 12 and the enclosure 14, in particular between the side portion 22 of the outer wall 16 and the inner wall 20, corresponds to an injection circuit with a substantially annular cross-section.

The flow calming assembly 10 here comprises an outer calming device 28.

In the depicted embodiment, the flow calming assembly 10 further comprises a flow distribution device 26.

The flow distribution device 26 distributes a flow of the fluid from the vessel 12 to the enclosure 14, for example in a known manner. In particular, the flow distribution device 26 is configured to make the flow of fluid entering the enclosure 14 uniform.

The flow distribution device 26, for example, comprises a side wall 30 and an interface 32.

The side wall 30 is devoid of openings for the passage of fluid.

The side wall 30 presents a symmetry along the main axis D.

The side wall 30 corresponds to a given contour translated along an axis.

In the represented embodiment, the side wall 30 is substantially cylindrical.

Alternatively, the given contour is a polygon.

The side wall 30 and the inner wall 20 are coaxial.

The interface 32 closes the lower end of the side wall 30.

The interface 32 is perpendicular to the axis around which extends the side wall 30

The interface 32 is, for example, in the shape of a disc. Alternatively, the interface 32 is in the shape of a polygon.

The interface 32 is, for example, a grid.

The grid, for example, has openings of a size comprised between the projected size of a fuel assembly and half the size of the pitch between fuel assemblies.

The outer calming device 28 radially surrounds the flow distribution device 26.

The outer calming device 28 is adapted to calm the flow of fluid upstream the enclosure 14 and, if applicable before the flow distribution device 26.

The outer calming device 28 has openings for the passage of fluid, as one embodiment will be described.

The outer calming device 28 extends from a bottom portion of the enclosure 14, in particular from the lower end of the enclosure 14, to a distance inferior to 10 centimeters, more precisely to 5 centimeters, to the bottom surface of the vessel.

More particularly, the distance between a lower end of the outer calming device 28 and the bottom surface 19 of the vessel 12 is comprised between 0,5 centimeters and 10 centimeters.

There is no contact between the outer calming device 28 and the vessel 12 apart from the protrusions 18.

The outer calming device 28 is not in contact with any pressurized wall of the vessel, the protrusions being not subject to pressure.

The outer calming device 28 has no contact with any pressurized element of the vessel 12.

In the represented embodiment, the outer calming device 28 comprises an upper part 34 and a lower part 36.

The upper part 34 comprises, more precisely is, a flared or conical collar.

The collar, more precisely the upper part 34, for example, has the shape of part of a cone that tapers from a base towards an apex, said apex being here located below the upper part. Alternatively, the collar, more precisely the upper part 34, for example, has a shape that is tapered from a base.

In the represented embodiment, the upper part 34 has a global shape that is substantially symmetrical by rotation around an axis, in particular around the main axis D.

The base is here circular. Thus, the upper part 34 comprises, more precisely is, a conical collar with a circular base.

Alternatively, the base is not circular.

The base has, for example, the shape of a polygon.

The upper part 34 extends between an upper end 38 and a lower end 40.

The upper end 38 has greater dimensions, in particular a greater diameter, than the lower end 40.

The upper part 34 is provided with a plurality of apertures 42.

The apertures 42 are arranged in columns. The apertures in one column are, for example, staggered relative to the apertures in the adjacent columns.

Each aperture 42 is, for example, round.

The total surface of the apertures is equal to between 10% and 60% of the surface of the upper part 34, here of the surface of the cone.

Each aperture has, for example, a diameter comprised between 30 mm and 100 mm.

Said diameter depends on the hydraulic optimization of the investigated reactor.

Fluid going through apertures 42 feeds directly the core periphery. In particular, the fluid going through apertures 42 does not go through the flow distribution device 26.

The shape of the lower part 36 presents a symmetry along the main axis D.

The shape of the lower part 36 corresponds to a given contour translated along said main axis.

The given contour is, for example, the contour of the lower end 40 of the upper part 34.

In the represented embodiment, the lower part 36 is cylindrical.

Alternatively, the contour has the shape of a polygon.

The lower part 36 here extends around the main axis D.

The main axis D is the axis of the cylinder.

The lower part 36 extends from the lower end 40 of the upper part 34.

The lower end 40 of the upper part 34 is coincident to the upper end of the lower part 36.

The lower part 36 is integral or fixed with the lower end 40 of the upper part 34. In the represented embodiment, the lower part 36 is integral with the upper part 34, the outer calming device 28 being made in one piece.

The lower part 36 has the same diameter as the lower end 40 of the upper part 34.

The lower part has, for example, a height comprised between 40% and 60% of the height of the outer calming device 28 along the main axis D.

The lower part 36 is provided with a plurality of rows of through-holes 44, the rows being, for example, staggered relative to the adjacent rows.

There are, for example, at least three rows of through-holes 44, for example three or four rows.

Each row corresponds to a circumference of the lower part 36.

The through-holes 44 are here rectangles, with fillets in the corners.

The through-holes 44 are arranged in a band portion 46 of the lower part 36.

Said band portion 46 extends from a lower end of the lower part 36.

The band portion 46 represent at least half of the lower part 36.

The through-holes 44 represent at least 75% of the surface of the band portion 46.

Each through-hole 44 has a surface area comprised between 150 cm² and 350 cm².

Each through-hole 44 has, for example, a length between 15 cm and 40 cm and a width between 5 cm and 15 cm.

The lower part 36 radially surrounds the flow distribution device 26, in particular the interface 32 of the flow distribution device 26.

Fluid passing through the through-holes 44 further go through the interface 32 of the flow distribution device 26.

In the represented embodiment, the outer calming device 28 is provided with a plurality of fasteners 48 attached to an upper end of said outer calming device 28, here the upper end 38, for connecting the outer calming device 28 with the vessel 12.

The fasteners 48 are attached, in particular here bolted, to ears 50 projecting from the upper end of the outer calming device 28.

The ears 50 are provided with holes, in particular threaded holes, for fastening, here bolting, the fastener 48 to the corresponding ears 50.

The ears project in a radial direction.

There are a pair of ears 50 for each fastener 48.

In the represented embodiment, the fasteners 48 are, for example, U-plates.

The fasteners 48 comprises two arms 52 and a central portion 54 connecting the two arms 52.

Each arm 52 is attached, in particular here bolted, to an ear 50.

Each arm 52 extends upwards from the ear 50.

Each arm 52 here extends substantially parallel to the main axis D.

The central portion 54 is thus higher than the corresponding arms 52.Each central portion 54 extends here perpendicular to the main axis D, along a local tangential direction relative to the outer calming device.

Each central portion 54 has a surface adapted to face and rest on an upper face of the corresponding protrusion 18.

In an alternative embodiment, the fasteners 48 further comprise a lower connecting portion connecting the two arms.

The lower connecting portion is adapted to partly face, in particular to contact with, a distal surface of the corresponding protrusion 18.

In the represented embodiment, there are as many fasteners 48 as there are protrusions 18.

Alternatively, there are more protrusions 18 than there are fasteners 48. In particular, the number of fasteners is comprised between half the number of protrusions and the number of protrusions. One would fasten between half and all the protrusions.

Each fastener 48 rests on a respective protrusion 18.

Each fastener 48, in particular each central portion 54, is further attached, in particular here bolted, to the respective protrusion.

The outer calming device 28 is fastened to the protrusions 18.

The outer calming device 28, for example, further comprises notches 55 for the passage of the protrusions 18.

In particular, between the ears of each pair of ears 50, the outer calming device 28 comprises one notch 55.

Thus, each protrusion 18 goes through the fastener 48, below the central portion 54, and through the notch 55.

Thus, each protrusion 18 is arranged between a corresponding fastener 48 located above and on most of the sides, and a corresponding notch 55 located below and partly on the sides.

If applicable, the lower connecting portion of the fastener extends through the corresponding notch, such as to surround the corresponding protrusion.

Alternatively, the outer calming device 28 is fastened to a lower plate of the nuclear core.

In the represented embodiment, the outer calming device 28 is further provided with a plurality of indexing elements 56.

The indexing elements 56 are, for example, holes, here at the upper end of the outer calming device.

The indexing elements 56 are, more precisely, pair of holes that are, for example, provided in extensions that extend from some pairs of ears 50.

The indexing elements 56 are adapted to cooperate with an insertion and/or extraction tool such as to insert or extract said outer calming device 28 in or from the vessel 12, as will be described later.

In operation, the fluid flowing from the injection circuit towards the enclosure 14 goes firstly through the outer calming device 28, in particular through the lower part 36 of the outer calming device 28, through the through-holes 44.

The distance between the lower end of the outer calming device 28 and the bottom surface of the vessel allows that most of the fluid goes firstly through the outer calming device 28.

The outer calming device 28 calms the flow of fluid upstream of the enclosure, and if applicable of the flow distribution device 26.

Most of the fluid goes through the through-holes 44 of the outer calming device 28, then goes through the flow distribution device 26, in particular the interface 32, such as to distribute the flow of fluid from the vessel 12 to the enclosure 14. The fluid finally enters the enclosure 14 through said flow distribution device 26.

Said fluid is thus firstly calmed and then distributed, such that the turbulences are reduced.

In the represented embodiment, some of the fluid goes through the apertures 42 to directly feed the core periphery. Said fluid is directly calmed by the outer calming device 28.

The shape of the outer calming device 28 is particularly advantageous for calming the flow of fluid upstream the enclosure. It notably favors a proper turn of the flow within the lower plenum.

A method for installing an outer calming device in a nuclear reactor, in particular an existing nuclear reactor, will now be described.

The nuclear reactor comprises a vessel and an enclosure situated in the vessel, as previously described.

In the described embodiment, the nuclear reactor is further provided with a flow distribution device, for example as previously described, for distributing a flow of the fluid from the vessel to the enclosure.

The nuclear reactor is however devoid of an outer calming device as previously described.

The method comprises the following steps:
emptying the vessel of internal structures and the nuclear fuel assemblies,
providing an outer calming device,
lowering the outer calming device in the vessel,
fastening the outer calming device inside the vessel, and
reinstalling the internal structures and the nuclear fuel assemblies in the vessel.

The step of emptying the vessel of internal structures and the nuclear fuel assemblies enables having access to the bottom of the vessel.

All the internal structures of the vessel are removed from said vessel.

The internal structures comprise the inner wall 20.

The internal structures comprise lower internal structures and upper lower structure.

The internal structures, in particular the lower internal structures, comprise the flow distribution device 26.

The lower internal structures carry the weight of the core, keep the fuel assemblies, control clusters and instrumentation in alignment, channel the flow of heat transfer fluid, protect the vessel from radiation emitted by the core, and always maintain a high degree of rigidity given the required alignment accuracy.

The upper internal structures position the control clusters rigorously in line with the fuel assemblies.

An outer calming device as previously described is provided and lowered inside the vessel.

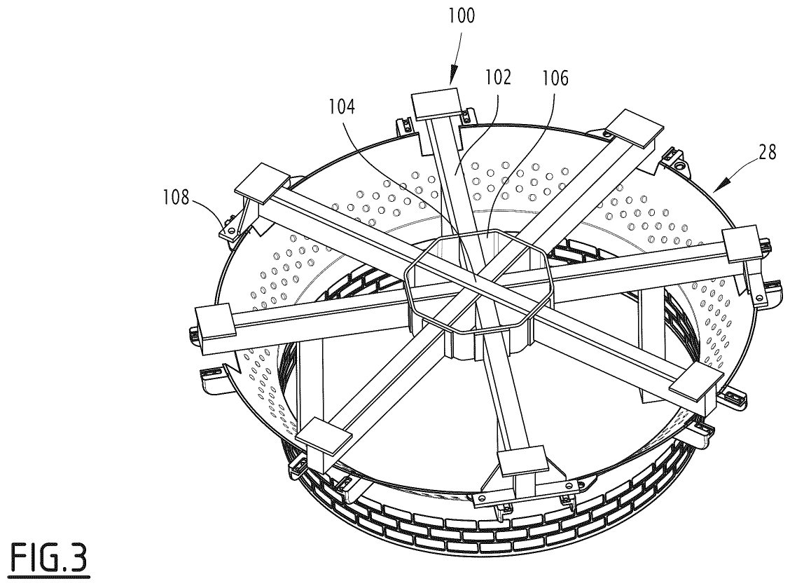

The outer calming device is, for example, handled by an insertion and/or extraction tool 100, as depicted on FIG. 3.

The tool 100 comprises a plurality, at least three, beams 102 that are attached together at a center 104.

The beams 102 are connected together, such that the middle of each beam is at the center 104.

The beams 102 extend in the same plane.

The beams 102 have a similar length.

The ends of the beams 102 are such that a circumscribed circle passes through all the ends of the beams.

The tool 100 further comprises a reinforcing structure 106, linking the beams 102 together at the center 104.

At some ends of the beams 102, are provided complementary elements 108 of the indexing elements 56.

The complementary elements 108 are adapted to cooperate with the indexing elements 56, such as to secure the tool 100 and the outer calming device 28 together.

The tool 100 and outer calming device 28 are, for example, secured by screwing or bolting.

The tool 100 is here secured to the outer calming device 28.

Thus, the tool 100 lowers the outer calming device 28 inside the vessel 12.

The outer calming device 28 is lowered so that it radially surrounds the flow distribution device and that it extends from a bottom portion of the enclosure to a distance inferior to 10 centimeters, more precisely 5 centimeters to the bottom surface of the vessel.

Said distance is comprised between 0.5 centimeters and 10 centimeters.

In particular, the outer calming device 28 is lowered until the fasteners 48 come in contact with the protrusions 18.

The tool 100 is then separated from the outer calming device 28 and removed.

The outer calming device 28 is then fastened inside the vessel 14, for example to the protrusions 18.

In particular, each fastener 48 is fastened to a corresponding protrusion 18.

In one embodiment, at least one bolt is screwed directly through each fastener 48, here through the central portion 54 and if applicable the lower connecting portion, and into the corresponding protrusion 18.

Alternatively, the outer calming device 28 is fastened to a lower plate of the nuclear core.

Then, all the elements that were removed from the vessel during the emptying step are reinstalled inside the vessel.

This method allows adding an outer calming device to an existing nuclear reactor, such that existing nuclear reactor have a flow calming assembly according to the present disclosure.

Further, said tool 100 is further adapted to extract the outer calming device 28 from the vessel 12, in particular for any maintenance operation.

In such a case, the outer calming device 28 is, for example, uncoupled from the fasteners 48, such that the fasteners 48 remain on the protrusions 18 and the outer calming device 28 is extracted from the vessel 12 without the fasteners.

Afterwards, the outer calming device 28 is reinstalled inside the vessel, such that the fasteners are-reattached to the outer calming device 28, here to the ears 50.

Alternatively, the fasteners 48 are uncoupled to the protrusions 18, such that the outer calming device 28 is extracted from the vessel 12 with the fasteners, the outer calming device 28 being reinstalled inside the vessel, such that the fasteners are repositioned on the protrusions.

The outer calming device is not directly attached to the pressure vessel wall and may be removed, in particular to inspect the entire vessel bottom.

The flow calming assembly of the present disclosure can undergo maintenance operations by extracting the outer calming device from the vessel.

The flow calming device of the present disclosure is particularly advantageous, as the flow of fluid is thus firstly calmed and then distributed, such that the turbulences of fluid flow at the entrance of the nuclear core are reduced.

What is claimed is:

1.-15. (canceled)

16. A flow calming assembly for a nuclear reactor comprising a vessel and an enclosure situated in the vessel,
wherein a fluid circulates from the vessel to the enclosure at a bottom part of the vessel,
wherein the flow calming assembly comprises an outer calming device, the outer calming device having openings for fluid passage, the outer calming device comprising an upper part and a lower part, the upper part comprising a flared or conical collar extending between an upper end and a lower end, the lower part having a shape presenting a symmetry along a main axis, the lower part extending from the lower end of the upper part.

17. The flow calming assembly according to claim 16, wherein the flow calming assembly comprises a flow distribution device for distributing a flow of the fluid from the vessel to the enclosure, the outer calming device radially surrounding the flow distribution device.

18. The flow calming assembly according to claim 16, wherein the outer calming device is configured to have no contact with any pressurized element of the vessel.

19. The flow calming assembly according to claim 16, wherein the upper end of the upper part has greater dimensions than the lower end.

20. The flow calming assembly according to claim 16, wherein the upper part comprises a flared or conical collar with a circular base, the lower part being cylindrical.

21. The flow calming assembly according to claim 16, wherein the lower part is provided with a plurality of rows of through-holes, the rows being staggered relative to the adjacent rows.

22. The flow calming assembly according to claim 16, wherein the upper part is provided with a plurality of apertures.

23. The flow calming assembly according to claim 17, wherein the lower part radially surrounds the flow distribution device.

24. The flow calming assembly according to claim 16, wherein the outer calming device is adapted to extend from a bottom portion of the enclosure to a distance between 0.5 centimeters and 10 centimeters to a bottom surface of the vessel.

25. The flow calming assembly according to claim 16, wherein the outer calming device is provided with a plurality of fasteners attached to an upper end of said outer calming device for fastening the outer calming device inside the vessel.

26. The flow calming assembly according to claim 16, wherein the outer calming device is provided with a plurality of indexing elements, the indexing elements being adapted to cooperate with an insertion and/or extraction tool such as to insert or extract said outer calming device in or from the vessel.

27. A nuclear reactor comprising:
a vessel;
an enclosure situated in the vessel wherein a fluid circulates from the vessel to the enclosure at a bottom part of the vessel; and
a flow calming assembly comprising an outer calming device, the outer calming device having openings for fluid passage, the outer calming device comprising an upper part and a lower part, the upper part comprising a flared or conical collar extending between an upper end and a lower end, the lower part having a shape presenting a symmetry along a main axis, the lower part extending from the lower end of the upper part.

28. A method for installing an outer calming device in a nuclear reactor comprising a vessel and an enclosure situated in the vessel, the nuclear reactor comprising a nuclear core located in the enclosure, a fluid circulating from the vessel to the enclosure at a bottom part of the vessel, the method comprising the following steps:
emptying the vessel of internal structures and nuclear fuel assemblies;
providing an outer calming device, the outer calming device having openings for fluid passage, the outer calming device comprising an upper part and a lower part, the upper part comprising a flared or conical collar extending between an upper end and a lower end, the lower part having a shape presenting a symmetry along a main axis, the lower part extending from the lower end of the upper part;
lowering the outer calming device in the vessel;
fastening the outer calming device inside the vessel; and
reinstalling the internal structures and the nuclear fuel assemblies in the vessel.

29. The method according to claim 28, wherein the outer calming device is fastened to protrusions radially protruding from an inner surface of the vessel and/or to a lower plate of the nuclear core.

30. The method according to claim 28, wherein the outer calming device is fastened such that the outer calming device extends from a bottom portion of the enclosure to a distance between 0.5 centimeters and 10 centimeters to a bottom surface of the vessel.
